(19) United States
(12) Patent Application Publication
(10) Pub. No.: US 2014/0304016 A1
(43) Pub. Date: Oct. 9, 2014

(54) REGULATING ASSET USE BY USER ENTITY

(71) Applicants: Todd A. Bynum, Friendswood, TX (US); Otto N. Fanini, Houston, TX (US)

(72) Inventors: Todd A. Bynum, Friendswood, TX (US); Otto N. Fanini, Houston, TX (US)

(73) Assignee: Baker Hughes Incorporated, Houston, TX (US)

(21) Appl. No.: 13/856,050

(22) Filed: Apr. 3, 2013

(51) Int. Cl. G06Q 10/06

(52) U.S. Cl. CPC G06Q 10/0631
USPC 705/7.12

(57) ABSTRACT

Methods and systems for regulating use of an asset by a user entity. The user entity may be bound by an asset use agreement providing the user entity a right to use the asset subject to at least one use limitation. Regulating use of the asset may be carried out using at least one processor in communication with a sensor, wherein the sensor is configured to sense a condition associated with the asset relating to at least one use limitation. The method may include generating a violation notification message for a managing entity when the at least one processor identifies a violation by the user entity of the at least one use limitation. The managing entity may be the entity responsible for regulating the user entity's use of the asset. The managing entity may be remote from the asset and/or the processor.

### BACKGROUND OF THE DISCLOSURE

Some types of capital-intensive or technologically complex commercial equipment may be well suited for business models involving leases. In return for compensation, owners of equipment or other assets may provide the use of an asset to a user entity, such as an end user or a third-party contractor, who will use the asset in various pursuits. Use of the asset may be granted on a contractual basis according to a use agreement. The owner (or other provider) may bind the user entity to the use agreement before providing the asset.

This business model is often found in the oil and gas services industry. Oil and gas companies may lease oilfield tools (e.g., seismic equipment, vehicles, drill string components, etc.) to a contractor for use at a client site remote from the lessor. The lease may be governed by a lease agreement to which the contractor agrees to be bound in order to procure the tools for use on a particular job.

### SUMMARY OF THE DISCLOSURE

In one aspect, this disclosure generally relates to methods, products, and systems for regulating use of an asset by a user entity. The user entity may be bound by an asset use agreement providing the user entity a right to use the asset subject to at least one use limitation. Regulating use of the asset may be carried out using at least one processor in communication with a sensor, wherein the sensor is configured to sense a condition associated with the asset relating to at least one use limitation. The method may include generating a violation notification message for a managing entity when the at least one processor identifies a violation by the user entity of the at least one use limitation. The managing entity may be the entity responsible for regulating the user entity's use of the asset. The managing entity may be remote from the asset and/or the processor. The managing entity may include at least one of i) an owner of the asset; ii) a lessor of the asset; iii) a licensor licensing rights relating to the asset; iv) a designated enforcement entity; v) a project manager.

General embodiments may include wherein the at least one use limitation comprises at least one of i) at least one contractual condition of the asset use agreement; ii) at least one legal condition governing at least one of the user entity, the managing entity, and the asset provider; and iii) at least one operation condition. The condition may relate to or include spatial information, such as, for example, depth information, altitude information, position information (e.g., geographical coordinates), orientation, and so on. At least one of the at least one processors may be remote from the asset. At least one of the at least one processors may be co-located at the asset.

General embodiments may also include using the at least one processor to perform at least one of i) generating the violation notification message responsive to a request message; and ii) identifying the violation condition autonomously; or using the at least one processor to identify the violation condition in response to a request message from at least one of: i) the remote managing entity; and ii) a second remote entity.

Some aspects may include transmitting the violation notification message and/or storing the violation notification message in a tamper-resistant computer-readable storage medium.

The use limitation may relate to at least one of i) permitting use of the asset only in one or more particular countries; and ii) prohibiting use of the asset in one or more particular countries.

Another embodiment according to the present disclosure includes a non-transitory computer-readable medium product having instructions thereon that, when read by at least one processor, causes the at least one processor to execute a method disclosed herein. For example, the computer-readable medium product may cause the at least one processor to execute a method comprising generating a violation notification message for a managing entity when the at least one processor identifies a violation by the user entity of the at least one use limitation.

Examples of the more important features of the disclosure have been summarized rather broadly in order that the detailed description thereof that follows may be better understood and in order that the contributions they represent to the art may be appreciated. There are, of course, additional features of the disclosure that will be described hereinafter and which will form the subject of the claims appended hereto.

### BRIEF DESCRIPTION OF THE DRAWINGS

For a detailed understanding of the present disclosure, reference should be made to the following detailed description of the embodiments, taken in conjunction with the accompanying drawings, in which like elements have been given like numerals, wherein:

FIGS. 1A &1B show a data flow diagram illustrating method embodiments according to the present disclosure;

FIG. 2 shows a system for regulating use of an asset by a user entity in accordance with embodiments of the present disclosure;

FIGS. 3A & 3B are data flow diagrams illustrating systems for regulation of asset use by a user entity in accordance with embodiments of the present disclosure;

FIG. 4 shows a schematic diagram of an example drilling system in accordance with embodiments of the disclosure;

FIG. 5 shows a system for regulating use of an asset by a user entity in accordance with embodiments of the present disclosure; and

FIG. 6 is a flow chart illustrating method embodiments in accordance with the present disclosure.

### DETAILED DESCRIPTION OF THE DISCLOSURE

The present disclosure relates to devices and methods for regulating use of an asset by a user entity. The present disclosure is susceptible to embodiments of different forms. There are shown in the drawings, and herein will be described in detail, specific embodiments of the present disclosure with the understanding that the present disclosure is to be considered an exemplification of the principles of the present disclosure and is not intended to limit the present disclosure to that illustrated and described herein.

Particular to certain industries is the importance (to the owner/provider) of limitations on the use of the asset by the user entity. This is typified by the oil and gas services industry. From the perspective of the provider, a complex matrix of business considerations governs the terms (e.g., required compensation) on which they are willing to lease an asset. Constraining use of the asset to particular job sites, fields, geological areas, sales or distribution territories, political boundaries, or other geographical constraints may greatly affect the terms of a lease, or whether the provider is willing to allow the contractor to use the asset at all. For example, the provider may charge different rates for different geographical restrictions. Conversely, the provider may wish to prohibit use according to geographical limitations. Additional spatial limitations such depth or altitude may also be considered. Other limitations may relate to environmental issues, health and safety issues, regulatory or other legal considerations (e.g., export control, licensing), appropriate use of the asset to avoid undue wear and damage and to maintain safety, and so on.

Consequently, one or more limitations may be included in a use agreement granting the user entity a right to use the asset. The user entity is bound to the terms of the use agreement, and is therefore contractually or legally obligated to use the asset according to the limitations. The limitations may relate to i) contractual conditions of the use agreement; ii) legal conditions governing at least one of the user entity, the managing entity, and the asset provider; or iii) operation conditions. The limitations may be directly or indirectly delineated in the use agreement. For example, the limitation may be incorporated into the use agreement by reference to other documents, such as, for example, exhibits, statutes, regulations, operating manuals, best-practices guides, and so on.

Enforcement of the limitations may be problematic. The totality of limitations desired by the provider may form a complex web of parameters which may be difficult for any party to monitor. Further, use of the asset in areas remote from the provider may compound the difficulty for monitoring and enforcement of the limitations on behalf of the provider. Individuals or departments representing the user entity in dealing with the provider may not be present at the job site. Moreover, it is often the case that the user entity or subdivisions thereof are indifferent or unwilling to adhere to the limitations. The user entity may attempt to use the asset outside of the scope of the agreed terms of the use agreement in violation of the limitations. For example, a user entity may attempt to use the asset in a region prohibited by the use agreement. Thus, infrastructure facilitating regulation of the user entity's adherence to one or more limitations of a use agreement may be desirable.

For various reasons, user entities often lack ownership of specialized tools or equipment which may be crucial to their interests. As described above, specialized providers may contract to provide a needed asset in return for compensation. The oilfield services industry is typical in this regard. Contractors may desire access to specialized oilfield tools to perform specific services for a client, but ownership of these tools may be financially or logistically prohibitive (or impossible) for the user entity.

The asset provider and the user entity may enter into a use agreement. Typical assets may include drill strings of the coiled tube type, of the jointed pipe type, bottom hole assemblies, subs, wireline tools, special purpose vehicles, and so on. The use agreement may be an agreement binding at least the user entity and granting a right to use an asset subject to at least one use limitation.

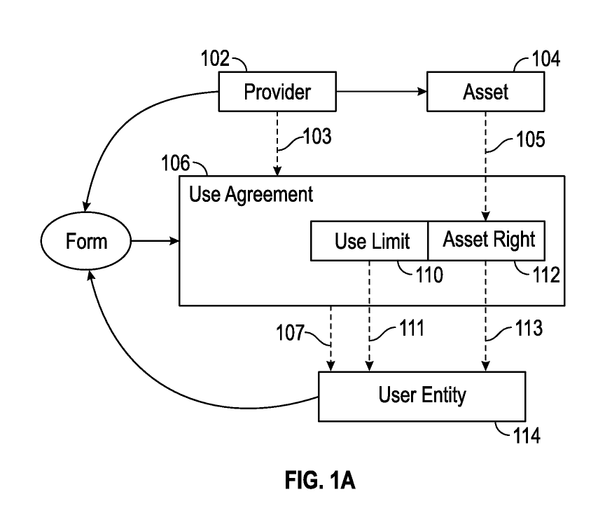

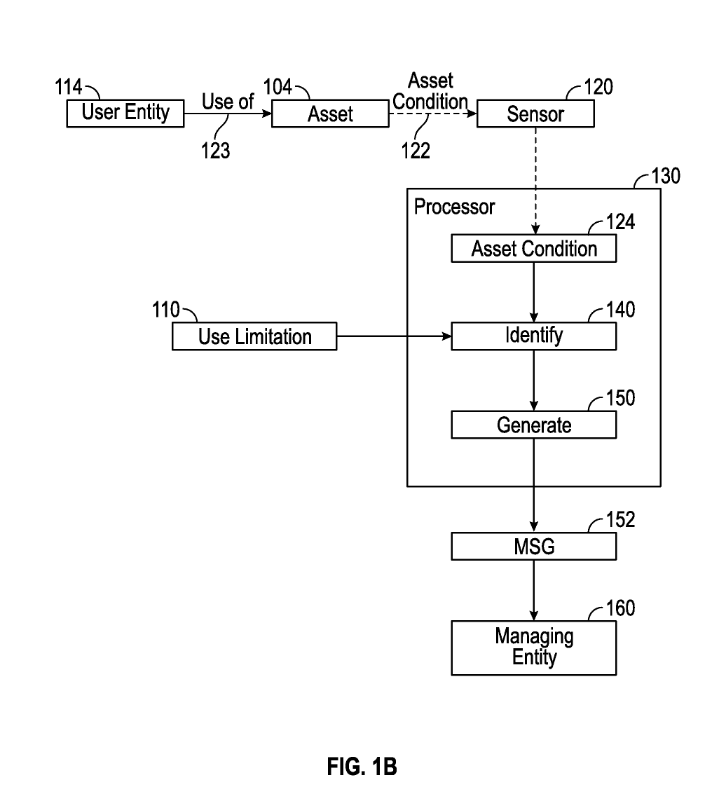

FIG. 1A shows a data flow diagram illustrating use agreement formation method embodiments according to the present disclosure. An asset provider 102 and a user entity 114 form (108) a contract pertaining to an asset 104 and embodied by a use agreement 106. The asset provider may be an owner, a leasing agent, a licensed distributor, a government entity, or a sub-division or subsidiary of these, or the like. The user entity may be a contractor or sub-contractor, an exploration company, a production company, a developer, a landowner, and so on.

The use agreement 106 binds (103, 107) asset provider 102 and user entity 114. Use agreement 106 provides (113) the right of use 112 for the asset 104 to the user entity 114 subject to at least one use limitation 110. The right of use may include one or more of a lease for an asset, a license to use intellectual property relating to an asset, or other rights related to use of the asset. Use limitation 110 is binding on the user entity 114 (relation 111).

A limitation may be provided in the language of the use agreement 106. The use agreement may be printed and executed as a hardcopy document, or may be in the format of an electronic document for use with common office document software (e.g., Portable Document Format). In some embodiments, the use agreement 106 may be implemented as or represented by a data set in a use regulation data repository accessible by a data processing device. The at least one use limitation may include i) at least one contractual condition of the asset use agreement; ii) at least one legal condition governing at least one of the user entity, the managing entity, and the asset provider; and/or iii) at least one operation condition.

A managing entity may be designated as an entity responsible for regulating the user entity's use of the asset. For example, the managing entity may be responsible for the user entity's adherence to the limitations under the use agreement. Thus, the managing entity may actively or passively monitor the user entity's use. The managing entity may determine whether a limitation violation has occurred. In some embodiments, the managing entity may be responsible for resolving the violation, either through communication with the user entity or related parties, through communication with authorities, or through direct action. In other embodiments, the managing entity notifies an asset owner or provider. In some implementations, a plurality of managing entities with distinct, overlapping, or identical responsibilities may regulate use of an asset.

FIG. 1B shows a data flow diagram illustrating regulation method embodiments according to the present disclosure. User entity 114 uses the asset 104 (123). Use of the asset may include assembly, power-up, or operation of an asset. Managing entity 160 is designated as a responsible entity for the asset 104. Sensor 120 is configured to sense (122) a condition 124 associated with the asset 104. The condition 124 relates to the at least one use limitation 110.

Example conditions may include operational conditions such as, for example, power state, emissions, transmissions, rotational speed, and so on; spatial information, such as, for example, depth information, altitude information, position information (e.g., geographical coordinates) at earth surface, ocean bottom, airborne or subsurface locations, well path survey, orientation, velocity, or combinations thereof, and so on. The condition may apply directly to the asset or to an associated reference point, such as, for example, a wellhead.

Sensor 120 may comprise one or more of a global positioning system (GPS) sensor, a location beacon sensor, a temperature sensor, a depth sensor (e.g., a depth wheel or true depth sensor), an altitude sensor, an electrical sensor, a radio frequency sensor, an angular velocity sensor, a speedometer, a gyroscope, an accelerometer, a magnetometer, and so on. In further examples, the sensor may provide information relating to a geological parameter, a geophysical parameter, a petrophysical parameter, and/or a lithological parameter. Example sensors may include formation evaluation sensors such as resistivity sensors, nuclear magnetic resonance (NMR) sensors, gamma ray detectors, and other sensors. Thus, sensors may include sensors for estimating formation resistivity, dielectric constant, the presence or absence of hydrocarbons, acoustic porosity, bed boundary, formation density, nuclear porosity and certain rock characteristics, permeability, capillary pressure, and relative permeability. It should be understood that this list is illustrative and not exhaustive.

Information provided by sensors may be combined to estimate a condition. For example, a GPS sensor at a surface location may sense signals transmitted from GPS satellites. A processor local to the sensor may determine GPS coordinates, and an asset may travel downhole from a starting point at the well head designed or sensed to be at particular location with respect to a reference point at the surface. The well location could also be determined by a directional survey service commonly provided in the oilfield industry. Information from an accelerometer or the like may determine displacement of the asset from the starting point. Processing the sensor information may include using the displacement information and reference information (e.g., the location of the reference point) in combination to determine the location of the asset.

One example system may include oilfield equipment used in a borehole at a well site. A well head location at an earth surface or ocean bottom may be determined by a location position vector and combined with a well location vector with respect to the well head on the top of the well. Directional and position survey algorithms may used to implement electronic compass and position determination. In some embodiments, the sensor may be implemented as a pre-calibrated and self-contained directional-surveying instrument that measures both the Earth's magnetic and gravitational forces. Inclination may be measured by gravity accelerometers, which measure the Earth's gravitational field in the x, y, and z planes. By convention, the z plane is along the tool axis, x is perpendicular to z and in line with the tool's reference slot, and y is perpendicular to both x and z. However, other coordinate systems may be used. From this measurement, the vector components may be summed to determine the borehole well inclination. Borehole well direction may be measured by gravity accelerometers and fluxgate magnetometers. Fluxgate magnetometers measure components of the Earth's magnetic field orthogonally (i.e., in the same three orthogonal axis similar to the accelerometers). From these measurements, the vector components may be summed to determine hole direction and inclination, by estimating the local reference magnetic field using directional survey measurement calibration models provided by the British Geological Survey (BGS) or the U.S. Geological Survey (USGS). The accelerometers may provide accelerations in three orthogonal directions (e.g., x, y and z). These accelerations can be used to keep track of the equipment's movement and translation from one reference or initial position (e.g. the well head or a well known reference position) to its present position within a time frame indexed by a calibrated precision real-time clock. The Earth's magnetic field measurements combined with accelerometer data can be combined and processed to establish the equipment position and orientation in the earth surface, ocean bottom, subsurface, or immersed location.

Depending on the packaging of the electronic sensors, the electronic-compass system may be employed in different modes, such as single deployment, multi-deployment, and MWD, in which data may be sent to the surface in real-time through a mud-pulse telemetry system or stored for later memory retrieval. An electronic magnetic directional survey shot may be used to record in a survey record while drilling the well. MWD tools may acquire downhole information during drilling operations that can be used to make timely operational decisions about the drilling process or to enable or disable (fully or partially) the equipment. The sensors may measure the Earth's magnetic and gravitational forces with fluxgate magnetometers and gravity accelerometers, respectively. Information from the sensors may be stored downhole in memory and retrieved at the surface to calculate the hole direction, inclination, tool face orientation, and well path within the earth with respect to a reference position (e.g., the wellhead), or summarized and encoded in mud pulses that are transmitted up to the surface for decoding. The well path and equipment location real-time survey information may enable a user entity to make directional-drilling decisions while drilling or operating the equipment. Some operational decisions may also be pre-programmed and embedded in the equipment to be automatically executed without external intervention.

Processor 130 is in communication with sensor 120. Processor 130 is configured to identify (140) a violation by the user entity of the at least one use limitation and generate (150) a violation notification message 152 for managing entity 160 when the at least one processor identifies the violation. Some embodiments may employ more than one processor. For example a first processor may identify the violation and a second processor may generate the violation message, or multiple processors may be used to perform either or both actions. One or more of the processors may be remote from the asset. Additionally or alternatively, one or more of the processors may be co-located at the asset. In some implementations, either or both of identification (140) and generation (150) may be carried out in real-time. In other implementations either or both may be delayed.

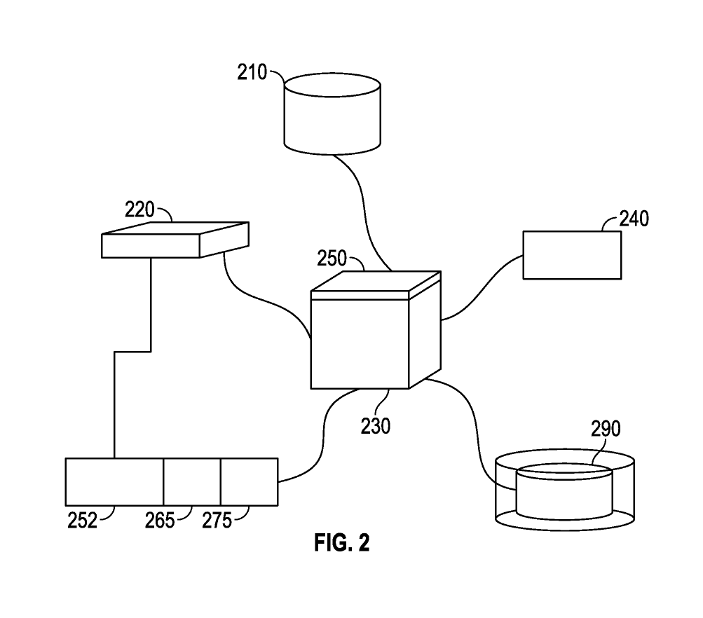

FIG. 2 shows a system 200 for regulating use of an asset by a user entity in accordance with embodiments of the present disclosure. As shown in FIG. 2, certain embodiments of the present disclosure may be implemented with a hardware environment that includes a processor 230, an information storage medium 210, a sensor 220, processor memory 250, and may include communications interface 240. Each component may be co-located, may form part of an integrated circuit, or may be remote from the other components. Communication between remote components may be implemented with additional appropriate communications interfaces for wired or wireless communication. Communications may take place over a network, such as one or more LANs, WANs, uplink telemetry (e.g., mud pulse), cellular networks, other wireless networks, and/or the Internet. In oilfield environments, the hardware environment may be in the well, in the asset 104, at the rig, at other surface locations at the well site, or at a remote location. Moreover, the several components of the hardware environment may be distributed among those locations. The sensor 220 may be any sensor as described above. The information storage medium 210 may store information provided by sensor 220. Information storage medium 210 may store a program that when executed causes information processor 230 to execute the disclosed method. Information storage medium 210 may also store use limitation information. Information storage medium 210 may include any programmable or non-programmable non-transitory computer information storage device, such as, but not limited to, a ROM, USB drive, memory stick, hard disk, removable RAM, EPROMs, EAROMs, EEPROM, flash memories, integrated circuit firmware, and optical disks, network based storage, or other commonly used memory storage system known to one of ordinary skill in the art including Internet based storage, or combinations thereof.

Processor 230 may be any form of computer or mathematical processing hardware, including Internet based hardware. When the program is loaded from information storage medium 210 into processor memory 230 (e.g. computer RAM), the program, when executed, causes processor 230 to generate a violation notification message for a managing entity in response to the processor 230 identifying a violation by the user entity of the at least one use limitation. In some embodiments, the program functionality may be implemented into processor 230 in part or in whole as hardwired logic circuits. Processor 230 may be located on the surface or downhole.

System 200 includes an asset 252 that includes sensor 220. Processor 230 receives information relating to a condition associated with the asset 252 relating to the at least one limitation from the sensor 220. Processor 230 is operatively coupled to an asset interface 275, through which information pertaining to operation conditions of the asset originating at status sensors 265 may be received. The processor may be configured to perform methods according to the present disclosure. Specifically, the processor may be configured to: use the response from the sensor to identify a violation by the user entity of the at least one use limitation; and generate a violation notification message for the managing entity. The processor 230 may also be configured to disable the asset 252 using asset interface 275 responsive to receiving a disable command (not shown) from the remote managing entity. Disablement may be partial or complete. For example, particular parts, subsystems, or operations of asset 252 may be disabled. Processor 230 is also operatively coupled to an appropriate communications interface 240 for transmission of the violation notification message to a remote entity.

Processor 230 is further operatively coupled to a tamper-resistant computer-readable storage medium 290. Processor 230 is configured to store a violation notification message in the tamper-resistant computer-readable storage medium 290, such that the user entity (or any entity other than the provider or managing entity) is unable to access or change the memory. Tamper-resistant computer-readable storage medium 290 may include physical measures, encryption, passcodes, or other information technology measures to avoid access from unauthorized parties.

A system log may be summarized and stored in an operational log file in the tamper-resistant computer-readable storage medium 290 which contains relevant events that are logged by a controller or supervisor module (e.g., processor 230) with an embedded sequential control function of decisions and operating steps of the equipment. This module may receive command and data communications and also respond to commands or internally stored programmed behavior with data and status, communicating these responses accordingly. The control module may proceed through steps in a sequential state machine based on commands received and internally pre-programmed steps. The equipment's controller may enable or activate the equipment functionality and resources and/or deploy operational accessories and support modules. These activities and sequential state events may be predetermined by the control module operating system and recorded in the system log file, which enables tracking and reconstruction of the operating history of the asset. System log files may contain information about operational and environmental conditions, command data received and transmitted, device execution program changes, device drivers, system changes, mathematical algorithms, position, enabled and disabled functions and capabilities, equipment operational health events, diagnostics, measurements, malfunction, decisions with or without external intervention, and so on.

A log file may be a recording of the operations and communications involving an asset. The information may be recorded chronologically, and may be located in a memory, in a root directory in a predetermined memory address and data format. The log file may reflect the asset's operational condition at every moment during its deployment and its historical utilization.

Upon recovery of the system by the owner, the provider, or the managing entity, the tamper-resistant computer-readable storage medium 290 may be accessed to determine the violation. Alternatively, the processor may be configured to later retrieve and transmit the information in the tamper-resistant computer-readable storage medium 290 upon receiving appropriate commands and/or key codes from the owner, the provider, or the managing entity, or upon detecting conditions suitable for transmission. Keycodes as well as other instructions, parameters, configuration data, or other data stored on tamper-resistant computer-readable storage medium 290 or information storage medium 210 may be preset by the owner, provider, or managing entity; or modified by any of these remotely.

In some embodiments, a first violation notification message may be stored in memory and a second violation notification message may be transmitted. The first and second message may comprise overlapping or identical information, or may comprise distinct information. In particular implementations, the first message may include detailed information, and the second message may include only summary information or only an indication that a violation by the user entity of the at least one use limitation has occurred.

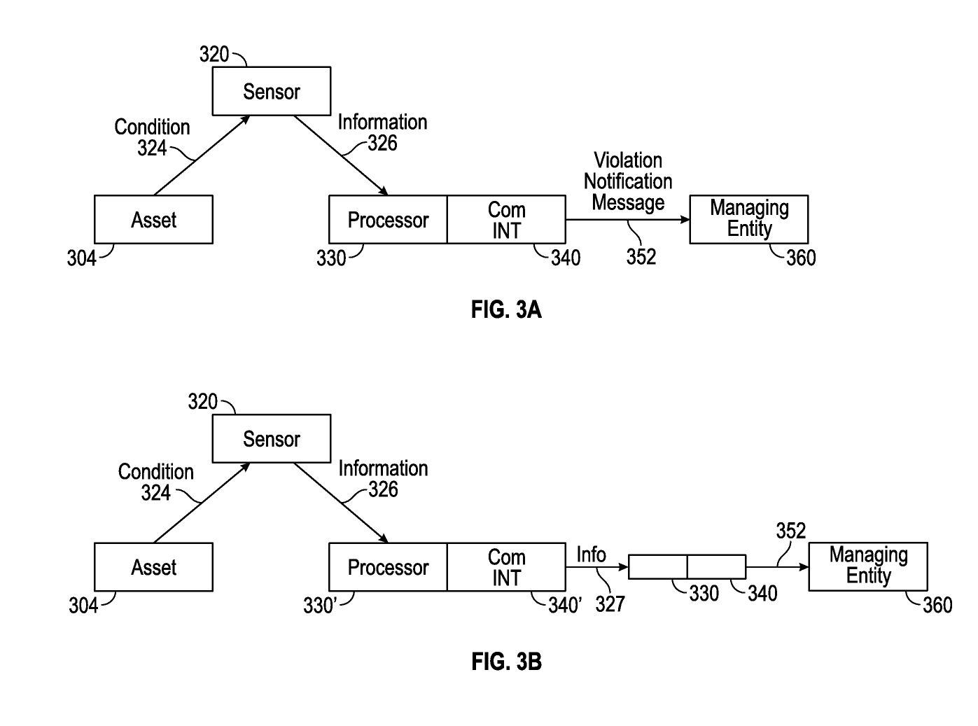

FIGS. 3A-3B are data flow diagrams illustrating systems for regulation of asset use by a user entity in accordance with embodiments of the present disclosure.

Referring to FIG. 3A, system 300 includes an asset 304, a co-located sensor 320 responsive to a condition 324 associated with the asset 304 relating to the at least one use limitation; and a co-located processor 330 in communication with the sensor 320. Sensor 320 may be part of asset 304 or a separate device. Processor 330 and sensor 320 may be may be implemented as several hardwired circuits, or as one or more Integrated Circuits (‘ICs’) (including as the same IC), or a combination of any of these. Processor 330 is also operatively coupled to an appropriate communications interface 340 for communications with a remote entity. Processor 330 receives information 326 relating to the condition 324 from the sensor 320, and is configured to perform methods according to the present disclosure. Specifically, processor 330 may be configured to: use the information 326 from the sensor 320 to identify a violation by the user entity of the at least one use limitation; and generate a violation notification message 352. The processor 330 is further configured to use communications interface 340 to transmit the violation notification 352 message to a remote managing entity 360.

Referring to FIG. 3B, system 300 includes an asset 304, a co-located sensor 320 responsive to a condition 324 associated with the asset 304 relating to the at least one use limitation; and a 330′ in communication with the sensor 320. Processor 330′ is also operatively coupled to an appropriate communications interface 340′ for communications with a remote entity. Processor 330′ receives information 326 relating to the condition 324 from the sensor 320, and is configured to transmit information 327 relating to the condition 324 from the sensor 320 to remote processor 330 via coupled communications interface 340. Processor 330′ may be configured to perform initial processing on information 326 to produce information 327, or information 327 may be identical to information 326.

Processor 330 receives information 327, and is configured to perform methods according to the present disclosure. Specifically, processor 330 may be configured to: use the information 327 to identify a violation by the user entity of the at least one use limitation; and generate a violation notification message 352. The processor 330 is further configured to use communications interface 340 to transmit the violation notification message 352 to a managing entity 360, which may be remote or local to processor 330. Managing entity 360 may include one or more processors and connected data storage devices. Violation notification message 352 may be implemented according to any messaging protocols or other communication protocols over any appropriate communication medium.

Assets as illustrated in the figures and description above are not limited to any particular application—any device or component may be utilized as an asset in the systems and methods of the previous illustrations. However, much of the equipment and devices used in connection with oil and gas services may be considered assets well-suited for use with the present disclosure. More particular illustrations of devices, systems, and methods of the present disclosure wherein the asset comprises oilfield equipment or components thereof are found below.

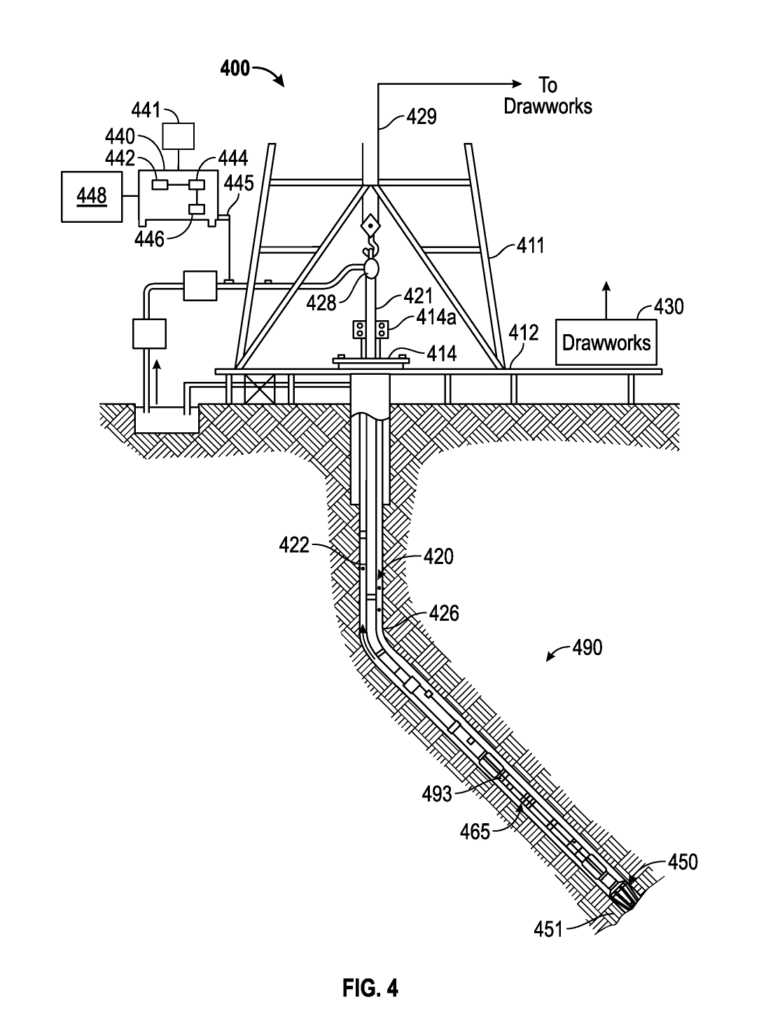

FIG. 4 shows a schematic diagram of an example drilling system in accordance with embodiments of the disclosure. Drilling system 410 includes a drill string 420 carrying a drilling assembly 490 (also referred to as the bottom hole assembly, or BHA) conveyed in a wellbore (borehole) 426 for drilling the wellbore. The BHA 490 and/or MWD tool 479 (below) may include components of the system for asset use regulation as described above.

The device may alternatively or additionally be located elsewhere on the drilling system. The drilling system 410 further includes a conventional derrick 411 erected on a floor 412, which supports a rotary table 414 that is rotated by a prime mover such as an electric motor (not shown) at a desired rotational speed. The drill string 420 includes a tubing such as a drill pipe 422 or a coiled-tubing extending downward from the surface into the borehole 426. The drill string 420 is pushed into the well bore 426 when a drill pipe 422 is used as the tubing. For coiled-tubing applications, a tubing injector (not shown), is used to move the tubing from a source thereof, such as a reel (not shown), to the wellbore 426. The drill bit 450 attached to the end of the drill string breaks up the geological formations when it is rotated to drill the borehole 426.

During drilling operations, a suitable drilling fluid 431 from a mud pit (source) 432 may be circulated under pressure through a channel in the drill string 440 by a mud pump 434. The drilling fluid passes from the mud pump 434 into the drill string 420. The drilling fluid 31 may be discharged at the borehole bottom 451 through an opening in the drill bit 450. The drilling fluid 431 may circulate uphole through the annular space 427 between the drill string 420 and the borehole 426 and return to the mud pit 432 via a return line 435. The drilling fluid acts to lubricate the drill bit 450 and to carry borehole cutting or chips away from the drill bit 450.

In one embodiment of the disclosure, the drill bit 450 is rotated by only rotating the drill pipe 422. In another embodiment of the disclosure, a downhole motor 455 (mud motor) is disposed in the drilling assembly 490 to rotate the drill bit 450 and the drill pipe 422 is rotated usually to supplement the rotational power, if required, and to effect changes in the drilling direction.

In the embodiment of FIG. 4, the mud motor 455 may be coupled to the drill bit 450 via a drive shaft (not shown) disposed in a bearing assembly 457. The mud motor may rotate the drill bit 450 when the drilling fluid 431 passes through the mud motor 455 under pressure. The bearing assembly 457 supports the radial and axial forces of the drill bit. A stabilizer 458 coupled to the bearing assembly 457 may act as a centralizer for the lowermost portion of the mud motor assembly.

A suitable telemetry or communication sub 472 using, for example, two-way telemetry, may also be provided. The drilling sensor module processes the sensor information and transmits it to the surface control unit 440 via the telemetry system 472. The communication sub 472, a power unit 478 and an MWD tool 479 may all be connected in tandem with the drillstring 420. The communication sub 472 obtains the signals and measurements and transfers the signals, using two-way telemetry (i.e., uplink, downlink), for example, to be processed on the surface by a processor at the surface control unit 440. Alternatively, the signals can be processed using a downhole processor in the drilling assembly 490.

The surface or downhole processor 230 may also receive signals from other downhole sensors (including sensors at the bit) and devices and signals from sensors used in the system 410 and process such signals according to programmed instructions provided to the processor 230. The surface control unit 440 may include a computer or a microprocessor-based processing system, memory for storing programs or models and data, a recorder for recording data, and other peripheral devices as described above.

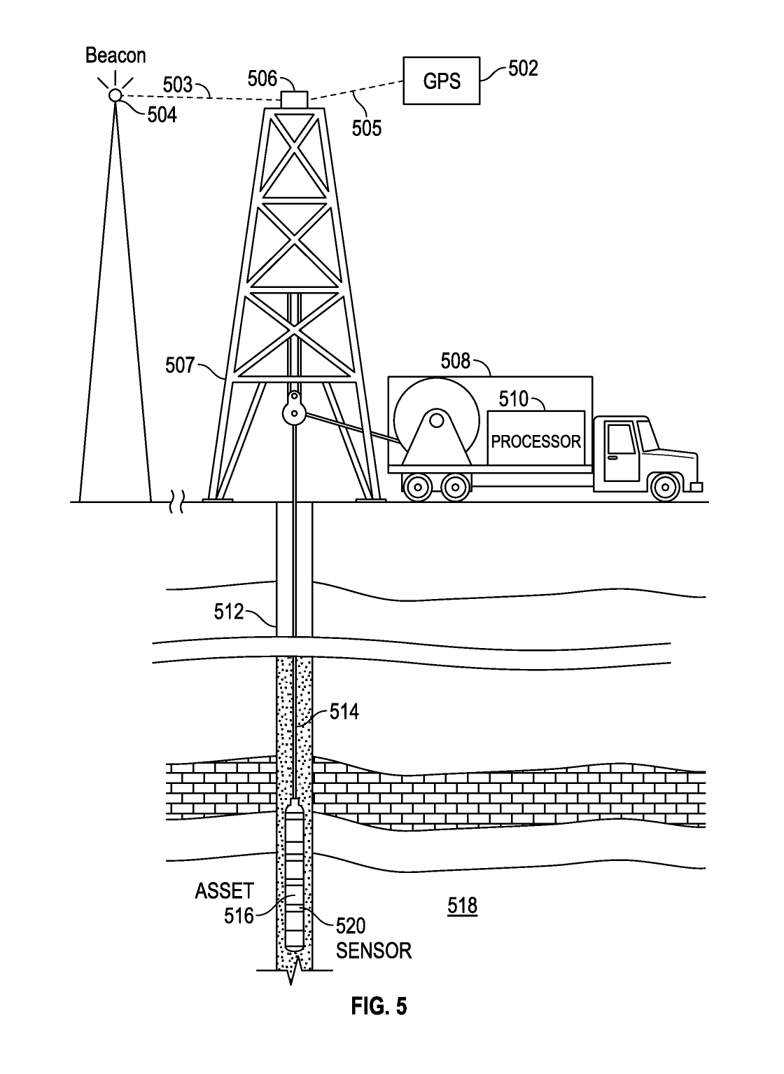

FIG. 5 shows a system 500 for regulating use of an asset by a user entity in accordance with embodiments of the present disclosure. FIG. 5 schematically illustrates a cross-section of an earth formation 518 intersected by a drilled wellbore 512. The system 500 includes an asset comprising a formation evaluation tool 516 suspended within the wellbore (borehole) 512 by a carrier 514. The tool 516 may include a sensor 520 as described above. Generally speaking, the sensor 520 may be any device that generates information in response to a condition of asset 516. The information may be a value, a relative value, a change in a value, etc. Sensor 520 may include a local processor for processing signals responsive to a condition associated with the asset. Another sensor 506 may be mounted at the surface and configured to receive global positioning signals 505 from global positioning system satellite 502 and/or positioning beacon signals 503 from radio frequency beacon 504. Sensor 506 may include a local processor for decoding these signals into geographical coordinate information.

The carrier 514 may be a data-conducting wireline supported by a derrick 507. Carrier 514 may also be implemented as wirepipe, wiretube, coiled tubing or slickline. A processor 510 communicates with the tool 516 and sensor 520 through the carrier 514. Processor 510 also communicates with sensor 506 via data communication media (e.g., fiber, wire) or wirelessly. Processor 510 receives information relating to a condition associated with the asset relating to the at least one limitation from the sensors 506, 520. Personnel may use the processor 510 to transmit electrical power, data/command signals, and to control operation of the tool 516. The processor may be configured to perform methods according to the present disclosure. Specifically, the processor may be configured to: use the response from the sensor to identify a violation by the user entity of the at least one use limitation; and generate a violation notification message for the managing entity. Processor 510 may also be operatively coupled to an appropriate communications interface 508 for transmission of the violation notification message to a remote entity.

In some embodiments, the borehole 512, 426 may be utilized to recover hydrocarbons. In other embodiments, the borehole 512, 426 may be used for geothermal applications, water production, mining, tunnel construction, or other uses.

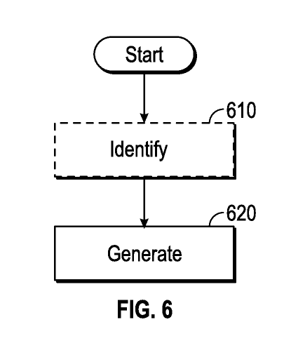

FIG. 6 is a flow chart illustrating method embodiments in accordance with the present disclosure. Optional step 610 of method 600 includes identifying a violation by the user entity of the at least one use limitation. The limitation may be embodied as a limitation data set stored in memory accessible to a processor performing the method. The limitation data set may be implemented as one or more limitation parameters. Identifying a violation may be carried out by comparing information representing the condition of the asset against the limitation parameters.

Geographical limitations may be implemented by comparing geographical information (e.g., GPS coordinates) and/or downhole position obtained from a location sensor against the limitation data set according to location algorithms, to determine if the sensor information indicates that the asset is in an area prohibited under the use agreement or the asset is not in one of one or more allowed areas under the use agreement, as defined by the limitation data set. If either test returns as ‘True’, a use limitation violation has occurred. Other limitation parameters may implement time limitations, either alone or in conjunction with other limitations. Violation may be determined against an internal or external calibrated real-time based time reference, such as, for example, an internal clock.

Other limitations may be carried out by comparing asset condition information against a threshold value represented by a limitation parameter. For example, information from a revolutions-per-minute (‘RPM’) sensor on a rotational component of the asset may be compared against a threshold RPM value. If the threshold is breached, a use violation has occurred. Similar thresholds may be set for temperature or pressure. Some embodiments may include evaluating information representing the condition of the asset using a rule, a state machine model, or a decision matrix.

Step 620 includes generating a violation notification message 152 for a managing entity when a violation is identified. Generating a violation notification message 152 may be carried out by using a communications interface to transmit information to a managing entity. In some embodiments, generating a violation notification message 152 may include storing the violation message in memory. The memory may be local to the asset. In some implementations, the memory may be tamper-proof memory, as described above. At least one processor may be used to perform at least steps 610-620.

The term “contract” as used herein means an agreement between two or more parties for the doing or not doing of something specified. The contract may involve an agreement between two or more entities in which there is a promise to perform in return for a benefit. The agreement may be enforceable by law.

Contractual use limitations described herein refer to limitations arising or stemming from a contractual relationship or from an agreement, or being conditions of use legally limiting the right of use, as described herein. Limitations may be related to permitting use of the asset only in one or more particular areas or prohibiting use of the asset in one or more particular areas. These areas may be defined as particular countries, regions, well sites, coordinates (latitude and longitude), depths, altitudes, and so on. A limitation may be explicitly provided in the use agreement (“use of the asset is prohibited in the following countries . . . .”) or provided by reference (“the asset shall be used in accordance with the operating manual,” “the asset shall be used in accordance with all applicable environmental laws and regulations of the nation of use,” etc.). A limitation may also be implicit, such as, for example, limitations prohibiting uses of the asset that are illegal or that may be harmful to the asset. The term bind or binding refers to constraining with obligation or legal authority.

The term “asset” as used herein means any tangible device, device component, combination of devices, media and/or member, or other assets that may be used to carry out a commercial function, including in some cases a specialized commercial function, including but not limited to engineering; geological, lithological, geophysical, or topological data acquisition, storage or processing; mineral, water or hydrocarbon prospecting, exploration, development, or completion, production, or pressure pumping; or devices otherwise facilitating the use of such device, device component, combination of devices, media and/or member. Exemplary non-limiting assets include vehicles, drill strings (of the coiled tube type or the jointed pipe type), subs, wireline tools, and/or any combination or component thereof. Specific examples include casing pipes, wirelines, wireline sondes, slickline sondes, drop shots, downhole subs, bottom hole assemblies, drill string inserts, modules, internal housings, and substrate portions thereof.

Operation conditions may refer to any aspect of the operations of the asset, including, but not limited to, power state, position, orientation, speed, velocity, acceleration, impact, rotation, weight on bit, torque, vibration, temperature, operation time, voltage, current, radio frequency signal, nuclear emission, particle emission, or any other measureable condition of the asset or components thereof, such as, for example, any characteristic typically measured in the use of the asset. Combinations of operation conditions may relate to expected asset life or changes in expected asset life. The term “co-located” as used herein means that two components are sufficiently in proximity to allow practical function of the components in the context of the claimed invention. For example, a co-located geographical coordinate sensor may be co-located with the asset if, allowing for a margin of error, the information regarding the location of the sensor is sufficient to determine if a limit violation has occurred.

The term “right of use” may include one or more of a right to use an asset; a license to use intellectual property relating to an asset, such as rights under a patent or copyright the scope of which includes one or more of the asset, a method of using the asset, or tangibly stored machine readable instructions causing or facilitating use of the asset; or other rights related to use of the asset.

The term “asset provider” as used herein means an entity forming an agreement with a user entity to provide the user entity with the asset. In various embodiments, the provider may be an owner of the asset, an agent of the owner, a seller, a political or regulatory body, or a subdivision of any of these. The term “user entity” as used herein means an entity using an asset or forming an agreement with an asset provider to use an asset. In one example, the user entity may be a joint venture entity formed by two or more managing entities (e.g., parent companies). The term “managing entity” may be an entity which regulates the use of the asset by the user entity and may include, but is not limited to, one or more of: an owner of the asset; ii) a lessor of the asset; iii) a licensor licensing rights relating to the asset; iv) a designated enforcement entity; v) or a project manager. As used herein, the term “project manager” means an entity serving as a manager of a project (e.g., a well development project) that contracts one or more other entities (e.g., user entities) to use an asset to perform services related to the project (e.g., drilling, completion). The project manager may or may not own or provide the asset. One example of a project manager in the oilfield context would be an operator contracting user entities to drill a well. The designated enforcement entity may be a business entity or a governmental entity charged with regulating the use of the asset. The designated enforcement entity may be a subdivision or subsidiary of the owner/provider or may otherwise be related, but could also be a stand-alone entity.

As used herein, a processor is any information processing device that transmits, receives, manipulates, converts, calculates, modulates, transposes, carries, stores, or otherwise utilizes information. In several non-limiting aspects of the disclosure, an information processing device includes a computer that executes programmed instructions for performing various methods. Herein, the term “information” may include one or more of: raw data, processed data, and signals. The processor may execute instructions stored in computer memory accessible to the processor, or may employ logic implemented as field-programmable gate arrays (‘FPGAs’), application-specific integrated circuits (‘ASICs’), other combinatorial or sequential logic hardware, and so on.

While the disclosure has been described with reference to exemplary embodiments, it will be understood that various changes may be made and equivalents may be substituted for elements thereof without departing from the scope of the disclosure. In addition, many modifications will be appreciated to adapt a particular instrument, situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

We claim:

1. A method of regulating use of an asset by a user entity with at least one processor in communication with a sensor, the user entity bound by an asset use agreement providing the user entity a right to use the asset subject to at least one use limitation, wherein the sensor is configured to sense a condition associated with the asset relating to the at least one use limitation, the method comprising:
generating a violation notification message for a managing entity when the at least one processor identifies a violation by the user entity of the at least one use limitation.

2. The method of claim 1, further comprising using the at least one processor to:
perform at least one of i) transmitting the violation notification message; and ii) storing the violation notification message in a tamper-resistant computer-readable storage medium;
perform at least one of i) generating the violation notification message responsive to a request message; and ii) identifying the violation condition autonomously; and
identify the violation condition in response to a request message from at least one of: i) the remote managing entity; and ii) a second remote entity;
wherein the at least one use limitation relates to the use of an oilfield tool in a borehole intersecting an earth formation, and the at least one use limitation comprises at least one of i) at least one contractual condition of the asset use agreement; ii) at least one legal condition governing at least one of the user entity, the managing entity, and the asset provider; and iii) at least one operation condition; and wherein the remote managing entity comprises at least one of i) an owner of the asset; ii) a lessor of the asset; iii) a licensor licensing rights relating to the asset; iv) a designated enforcement entity; and v) a contractor; and wherein the condition relates to spatial information comprising position information and at least one of: i) depth information, and ii) altitude information; wherein at least one of the at least one processors is co-located at the asset; and wherein the use limitation relates to at least one of i) permitting use of the asset only in one or more particular countries; and ii) prohibiting use of the asset in one or more particular countries.

3. The method of claim 1, wherein the at least one use limitation comprises at least one of i) at least one contractual condition of the asset use agreement; ii) at least one legal condition governing at least one of the user entity, the managing entity, and the asset provider; and iii) at least one operation condition.

4. The method of claim 1, wherein the remote managing entity comprises at least one of i) an owner of the asset; ii) a lessor of the asset; iii) a licensor licensing rights relating to the asset; iv) a designated enforcement entity; and v) a project manager.

5. The method of claim 1, wherein the condition comprises spatial information.

6. The method of claim 5, wherein the spatial information comprises at least one of: i) depth information; and ii) altitude information.

7. The method of claim 5, wherein the spatial information comprises position information including geographical coordinates.

8. The method of claim 1, wherein at least one of the at least one processors is remote from the asset.

9. The method of claim 1, wherein at least one of the at least one processors is co-located at the asset.

10. The method of claim 9, further comprising using the at least one processor to disable the asset responsive to receiving a disable command from the remote managing entity.

11. The method of claim 1, further comprising using the at least one processor to perform at least one of i) generating the violation notification message responsive to a request message; and ii) identifying the violation condition autonomously.

12. The method of claim 1, further comprising using the at least one processor to identify the violation condition in response to a request message from at least one of: i) the remote managing entity; and ii) a second remote entity.

13. The method of claim 1, further comprising transmitting the violation notification message.

14. The method of claim 1, further comprising storing the violation notification message in a tamper-resistant computer-readable storage medium.

15. The method of claim 1, wherein the use limitation relates to permitting use of the asset only in one or more particular countries, prohibiting use of the asset in one or more particular countries, or combinations thereof.

16. A system for regulating use of an asset by a user entity, the user entity bound by an asset use agreement providing the user entity a right to use the asset subject to at least one use limitation, the system comprising:
an asset;
a sensor responsive to a condition associated with the asset relating to the at least one use limitation;
a communication interface at the asset;
at least one processor in communication with the sensor, the at least one processor configured to:
use the response from the sensor to identify a violation by the user entity of the at least one use limitation; and
generate a violation notification message for the managing entity.

17. The system of claim 16, wherein the at least one use limitation comprises at least one of i) at least one contractual condition of the asset use agreement; ii) at least one legal condition governing at least one of the user entity, the managing entity, and the asset provider; and iii) at least one operation condition.

18. A non-transitory computer-readable medium product having instructions thereon that, when executed, cause at least one processor in communication with a sensor to perform a method of regulating use of an asset by a user entity, the user entity bound by an asset use agreement providing the user entity a right to use the asset subject to at least one use limitation, wherein the sensor is configured to sense a condition associated with the asset relating to the at least one use limitation, the method comprising:
generating a violation notification message for a managing entity when the at least one processor identifies a violation by the user entity of the at least one use limitation.

19. The non-transitory computer-readable medium product of claim 19 further comprising at least one of: (i) a ROM, (ii) an EPROM, (iii) an EEPROM, (iv) a flash memory, (v) a magnetic memory, and (vi) an optical disk.
